(19) United States
(12) Patent Application Publication
(10) Pub. No.: US 2023/0089370 A1
(43) Pub. Date: Mar. 23, 2023

(54) COST-SAVING MEMBRANE-ELECTRODE ASSEMBLY WITH IMPROVED STABILITY

(71) Applicants: Hyundai Motor Company, Seoul (KR); Kia Corporation, Seoul (KR)

(72) Inventor: Hyun Young Pi, Yongin (KR)

(21) Appl. No.: 17/946,122

(22) Filed: Sep. 16, 2022

(30) Foreign Application Priority Data
Sep. 17, 2021 (KR) 10-2021-0124444

(51) Int. Cl. H01M 4/92; H01M 8/1004

(52) U.S. Cl. CPC H01M 4/921; H01M 8/1004; H01M 2004/8689

(57) ABSTRACT

Disclosed herein is a cathode structure, a membrane-electrode assembly including the same, and a fuel cell including the same.

### CROSS-REFERENCE TO RELATED APPLICATION

This application claims under 35 U.S.C. § 119(a) the benefit of priority to Korean Patent Application No. 10-2021-0124444 filed on Sep. 17, 2021, the entire contents of which are incorporated herein by reference.

### TECHNICAL FIELD

The present invention relates to a cost-saving membrane-electrode assembly with improved stability and a fuel cell including the same.

### BACKGROUND

A vehicle equipped with a fuel cell obtains power from electricity produced by the reaction of hydrogen and air in a stack. A unit cell where the actual reaction occurs includes an electrode in which hydrogen and air contact, a membrane through which hydrogen ions move, and a metal separator through which electrons move. In each unit cell, an amount of power of 0.2 kW to 0.25 kW is generated. Hundreds of unit cells are stacked and connected in series to drive a vehicle. The fuel cell is subject to various power requirement such as acceleration/deceleration, long-term parking, and uphill traveling, and their durability performance is dependent upon water that is a byproduct of the current production.

For the commercialization of the vehicle equipped with the fuel cell, three major requirements should be met: a material cost of a precious metal such as platinum used as a catalyst, durability, and the establishment of a hydrogen charging infrastructure.

In the related art, there is a problem in that nano-sized platinum particles are easily agglomerated, thereby reducing the active area. This leads to an increase in material cost and a decrease in durability. In addition, the platinum catalyst has a disadvantage in that the deviation in which durability is reduced is large for each portion in a fuel cell stack with a dynamic operating environment. To solve this problem, a platinum-metal alloy catalyst has been proposed.

However, the alloy catalyst still requires further improvement as the operating performance of the alloy catalyst in various operating environments such as low initial performance and low or high temperature is significantly lower than that of the non-alloy catalyst.

The above information disclosed in this Background section is only for enhancement of understanding of the background of the invention and accordingly it may include information that does not form the prior art that is already known in this country to a person of ordinary skill in the art.

### SUMMARY

In preferred aspects, provided is a membrane-electrode assembly having improved durability and stability and manufactured with reduced material cost.

The object of the present invention is not limited to the aforementioned object. The object of the present invention can be more apparent by the following description, and will be implemented by the means disclosed in the claims and in combination thereof.

In an aspect, provided is a cathode structure to be integrated into a fuel cell including an air introduction portion and an air discharge portion. Particularly, the cathode structure may include: a first region disposed close to the air introduction portion when the cathode structure is integrated into the fuel cell and including a first catalyst; and a second region being the remaining region excluding the first region and including a second catalyst.

The first catalyst may include a first support body and an alloy catalyst supported by the first support body, and the second catalyst may include a second support body and a non-alloy catalyst supported by the second support body.

The cathode structure may include a pair of long sides facing each other and a pair of short sides facing each other, and the first region may be disposed along any one short side.

The cathode structure may include a pair of long sides facing each other and a pair of short sides facing each other, and the first region may be disposed along any one long side.

The first region may occupy about 30% to 70% of a surface area of the cathode structure.

The alloy catalyst may have a formula of Pt-M where M includes one or more selected from a group consisting of Co, Ni, Ru, Cu, Fe, and Au.

The first catalyst may include an amount of about 40 wt % to 80 wt % of the alloy catalyst and an amount of about 20 wt % to 60 wt % of the first support body based on the total weight of the first catalyst.

The non-alloy catalyst may include a platinum (Pt).

The second catalyst may include an amount of about 30 wt % to 70 wt % of the non-alloy catalyst and an amount of about 30 wt % to 70 wt % of the second support body based on the total weight of the second catalyst.

In an aspect, provided is a fuel cell including a cathode structure, an air introduction portion, and an air discharge portion.

The cathode structure may include: a first region disposed close to the air introduction portion when the cathode structure is integrated into the fuel cell and comprising a first catalyst; and a second region being the remaining region excluding the first region and comprising a second catalyst. Particularly, the first catalyst may include a first support body and an alloy catalyst supported by the first support body, and the second catalyst may include a second support body and a non-alloy catalyst supported by the second support body.

The cathode structure may include a pair of long sides facing each other and a pair of short sides facing each other, and wherein the first region is disposed along any one of the pair of short sides.

The cathode structure may include a pair of long sides facing each other and a pair of short sides facing each other, and the first region is disposed along any one of the pair of long sides.

The first region may occupy about 30% to 70% of a surface area of the cathode structure.

The alloy catalyst has a formula of Pt-M, where M comprises one or more selected from a group consisting of Co, Ni, Ru, Cu, Fe, and Au.

The first catalyst may include an amount of about 40 wt % to 80 wt % of the alloy catalyst and an amount of about 20 wt % to 60 wt % of the first support body, based on the total weight of the first catalyst. Preferably, the non-alloy catalyst may include a platinum (Pt).

The second catalyst may include an amount of about 30 wt % to 70 wt % of the non-alloy catalyst and an amount of about 30 wt % to 70 wt % of the second support body, based on the total weight of the second catalyst.

Also provided is a membrane-electrode assembly including the cathode structure as described herein.

According to various exemplary embodiments of the present invention, a membrane-electrode assembly with improved durability and stability may be obtained.

According to various exemplary embodiments of the present invention, the amount of the precious metal catalyst may be reduced, thereby reducing the material cost of the membrane-electrode assembly.

According to various exemplary embodiments of the present invention, the stability may be improved according to the initial performance and the operation environments that are the disadvantages of the alloy catalyst.

The effects of the present invention are not limited to the aforementioned effects. The effects of the present invention should be understood as including all effects inferable from the following description.

The other aspects of the invention are discussed infra.

### BRIEF DESCRIPTION OF THE DRAWINGS

The above and other features of the present invention will now be described in detail with reference to certain exemplary examples thereof illustrated in the accompanying drawings which are given herein below by way of illustration only, and thus are not limitative of the present invention, and wherein:

FIG. 1 schematically shows a fuel cell according to an exemplary embodiment of the present invention.

FIG. 2 shows a plan diagram showing a frame part according to an exemplary embodiment of the present invention.

FIG. 3 shows a cross-sectional diagram showing a membrane-electrode assembly according to an exemplary embodiment of the present invention.

FIG. 4 shows a first exemplary embodiment of a cathode structure according to an exemplary embodiment of the present invention.

FIG. 5 shows a second exemplary embodiment of a cathode structure according to an exemplary embodiment of the present invention.

FIG. 6 shows a cathode structure in Comparative example 1.

FIG. 7 shows a cathode structure in Comparative example 2.

FIG. 8 shows a cathode structure in Comparative example 3.

FIG. 9 shows a cathode structure in Comparative example 4.

FIG. 10 shows the results of measuring the initial performance of the fuel cells having the cathode structures in Examples 1 and 2 and Comparative examples 1 to 4.

FIG. 11 shows the results of measuring low temperature (30° C.) performance of the fuel cells having the cathode structures in Examples 1 and 2 and Comparative examples 1 to 4.

FIG. 12 shows the results of measuring high temperature (75° C.) performance of the fuel cells having the cathode structures in Examples 1 and 2 and Comparative examples 1 to 4.

FIG. 13 shows the results of measuring durability performance of the fuel cells having the cathode structures in Example 1 and Comparative examples 1 and 2.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in section by the particular intended application and use environment.

In the figures, reference numbers refer to the same or equivalent sections of the present invention throughout the several figures of the drawing.

### DETAILED DESCRIPTION

The above objects, other objects, features, and advantages of the present invention will be readily understood through the following preferred exemplary embodiments related to the accompanying drawings. However, the present invention is not limited to the exemplary embodiments described herein and can also be specified in other forms. Rather, the exemplary embodiments described herein are provided so that the disclosed contents can be thorough and complete and the spirit of the present invention can be sufficiently conveyed to those skilled in the art.

Similar reference numerals have been used for similar components while describing each drawing. In the accompanying drawings, the dimensions of the structures are shown larger than those of the real ones for the clarity of the present invention. The terms first, second, etc. can be used to describe various components, but the components should not be limited to the above terms. The terms are used only for the purpose of distinguishing one component from another. For example, a first component can be named as a second component without departing from the scope of the present invention, and similarly, the second component can also be named as the first component. The singular expression includes a plurality of expressions unless the context clearly mean otherwise.

In the present specification, it should be understood that the term “include” or “have” is intended to specify the presence of features, numbers, steps, operations, components, parts or combinations thereof described in the specification, and does not preclude the possibility of the presence or addition of one or more other features or numbers, steps, operations, components, parts or combinations thereof in advance. In addition, if an element such as a layer, a membrane, a region, a plate, etc. is said to be “on” another portion, this includes not only a case where it is “directly above” another portion, but also a case where it has other parts interposed therebetween. Conversely, if an element such as a layer, a membrane, a region, a plate, etc. is said to be “under” another portion, this includes not only a case where it is “directly under” another portion, but also a case where it has other portions interposed therebetween.

Unless otherwise specified, since all numbers, values, and/or expressions representing components, reaction conditions, polymer compositions, and an amount of mixtures used in the present specification are approximations reflecting various uncertainties of measurements that essentially occur in obtaining these values from the others, it should be understood that all cases are expressed by the term “about”. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2?, 1%, 0.5%, 0.1%, 0.05%, or 0.01% of the stated value. Unless otherwise clear from the context, all numerical values provided herein are modified by the term “about.”

In addition, if the numerical range is disclosed in the present invention, this range is continuous, and includes all values from the minimum value to the maximum value in this range unless indicated otherwise. Furthermore, if this range refers to an integer, all integers including the minimum value to the maximum value are included unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

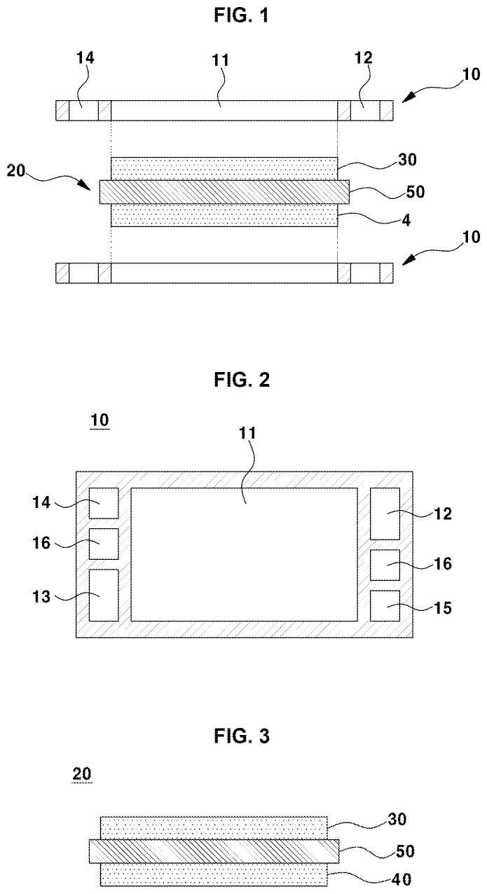

FIG. 1 schematically shows a fuel cell according to the present invention. The fuel cell can include a membrane-electrode assembly 20 and a frame part 10 bonded on both surfaces of the membrane-electrode assembly 20.

FIG. 2 shows a plan diagram showing the frame part 10. The frame part 10 can be a gasket, a separator, or a fuel cell component.

The frame part 10 has a center portion 11 formed to penetrate, and therefore, the membrane-electrode assembly 20 is seated.

The frame part 10 may include an air introduction portion 12 and an air discharge portion 13 formed at locations facing each other with respect to the center portion 11. For example, referring to FIG. 2, when the air introduction portion 12 is located on an upper right side of the frame part 10, the air discharge portion 13 may be located on a lower left side thereof.

The frame part 10 may include a fuel introduction portion 14 and a fuel discharge portion 15 formed at locations facing each other with respect to the center portion 11. For example, referring to FIG. 2, when the fuel introduction portion 14 is located on an upper left side of the frame part 10, the fuel discharge portion 15 may be located on the lower right side thereof.

A coolant manifold 16 formed to penetrate so that the coolant flows may be located between the air introduction portion 12 and the fuel discharge portion 15 and between the fuel introduction portion 14 and the air discharge portion 13.

FIG. 3 is a cross-sectional diagram showing the membrane-electrode assembly 20. The membrane-electrode assembly 20 may include a cathode 30, an anode 40, and an electrolyte membrane 50 located between the cathode 30 and the anode 40.

The present invention is characterized by the cathode 30 structure related to the air introduction portion 12 and the air discharge portion 13 in constituting the fuel cell by coupling the membrane-electrode assembly 20 with the frame part 10.

The cathode 30 structure for being integrated into the fuel cell including the air introduction portion 12 and the air discharge portion 13 may include (i) a first region 31 disposed close to the air introduction portion 12 and including a first catalyst and (ii) a second region 32 being the remaining region excluding the first region 31 and including a second catalyst.

The first catalyst of the first region 31 may include a first support body and an alloy catalyst supported by the first support body. In particular, the alloy catalyst may be disposed in the first region 31 on the air introduction portion 12 side, and a non-alloy catalyst including a precious metal may be disposed in the second region 32 being the remaining region, thereby taking only the advantage of each catalyst.

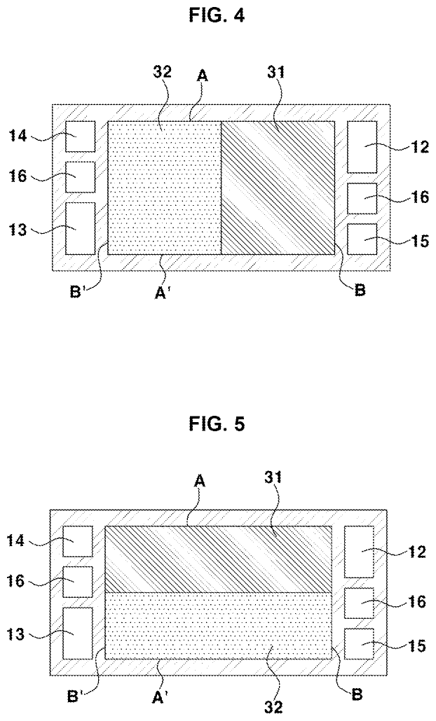

FIG. 4 shows a first exemplary embodiment of the cathode 30 structure according to the present invention. For example, the cathode 30 structure may include a pair of long sides (A, A′) facing each other and a pair of short sides (B, B′) facing each other, and the first region 31 may be disposed along any one of the pair of short sides (B) located on the air introduction portion 12 side.

Where the description of “disposed along the short side” means that a certain portion is disposed to occupy a certain area toward the center portion therefrom based on the short side.

FIG. 5 shows a second exemplary embodiment of the cathode 30 structure according to an exemplary embodiment of the present invention. For example, the cathode 30 structure may have the first region 31 disposed along any one of the pair of long sides (A) located on the air introduction portion 12 side.

The first region 31 may occupy an area of about 30% to 70% of a surface area of the cathode 30 structure. When the area of the first region 31 is less than about 30%, it is difficult to achieve the introduction purpose of the alloy catalyst, and when it is greater than about 70%, the performance of the membrane-electrode assembly 20 may be reduced.

The alloy catalyst of the first catalyst may have a formula of Pt-M, and M includes one or more selected from a group consisting of Co, Ni, Ru, Cu, Fe, and Au.

The first support body of the first catalyst may include any support body as long as it is a support body generally used in the art to which the present invention pertains. For example, the first support body may include a carbon-based support body or an inorganic-based support body.

The first catalyst may include an amount of about 40 wt % to 80 wt % of the alloy catalyst and an amount of about 20 wt % to 60 wt % of the first support body, based on the total weight of the first catalyst.

The non-alloy catalyst of the second catalyst may suitably include platinum (Pt).

The second support body of the second catalyst may include any support body as long as it is a support body generally used in the art to which the present invention pertains. For example, it may include a carbon-based support body or an inorganic-based support body.

The second catalyst may include an amount of about 30 wt % to 70 wt % of the alloy catalyst and an amount of about 30 wt % to 70 wt % of the second support body, based on the total weight of the second catalyst.

A method for manufacturing the cathode 30 structures shown in FIGS. 4 and 5 is not particularly limited. For example, a slurry including the first catalyst and a slurry including the second catalyst may be directly applied on a substrate or an electrolyte membrane in target shapes. Alternatively, the first region and the second region may be formed on a release paper and then, also transferred to the electrolyte membrane.

### EXAMPLE

Hereinafter, the present invention will be described in detail with reference to the following Examples and Comparative examples. However, the technical spirit of the present invention is not limited and restricted thereto.

### Example 1

As shown in FIG. 4, the cathode structure having the first region 31 disposed along the short side (B) to be located on the air introduction portion 12 side was implemented. The first region 31 was formed to occupy 50% of the surface area of the cathode structure. A platinum loading amount of the alloy catalyst of the first region 31 was adjusted to 0.25 mgPt/cm2, and a platinum loading amount of the non-alloy catalyst of the second region 32 was adjusted to 0.4 mgPt/cm2.

### Example 2

As shown in FIG. 5, the cathode structure having the first region 31 disposed along the long side (A) to be located on the air introduction portion 12 side was implemented. The first region 31 was formed to occupy 50% of the surface area of the cathode structure. A platinum loading amount of the alloy catalyst of the first region 31 was adjusted to 0.25 mgPt/cm2, and a platinum loading amount of the non-alloy catalyst of the second region 32 was adjusted to 0.4 mgPt/cm2.

### Comparative Example 1

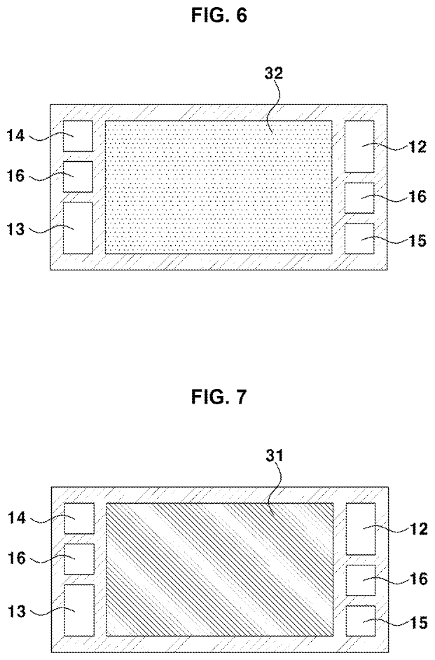

As shown in FIG. 6, the cathode structure was composed of the second region 32 all including the non-alloy catalyst. The platinum loading amount of the non-alloy catalyst of the second region 32 was adjusted to 0.4 mgPt/cm2.

### Comparative Example 2

As shown in FIG. 7, the cathode structure was composed of the first region 31 all including the alloy catalyst. The platinum loading amount of the alloy catalyst of the first region 31 was adjusted to 0.25 mgPt/cm2.

### Comparative Example 3

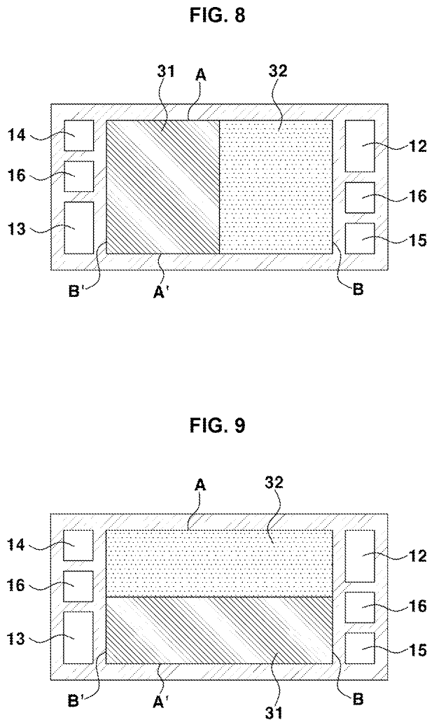

As shown in FIG. 8, the cathode structure having the first region 31 disposed along the short side (B′) to be located on the air discharge portion 13 side was implemented. The first region 31 was formed to occupy 50% of the surface area of the cathode structure. A platinum loading amount of the alloy catalyst of the first region 31 was adjusted to 0.25 mgPt/cm2, and a platinum loading amount of the non-alloy catalyst of the second region 32 was adjusted to 0.4 mgPt/cm2.

### Comparative Example 4

As shown in FIG. 9, the cathode structure having the first region 31 disposed along the long side (A′) to be located on the air discharge portion 13 side was implemented. The first region 31 was formed to occupy 50% of the surface area of the cathode structure. A platinum loading amount of the alloy catalyst of the first region 31 was adjusted to 0.25 mgPt/cm2, and a platinum loading amount of the non-alloy catalyst of the second region 32 was adjusted to 0.4 mgPt/cm2.

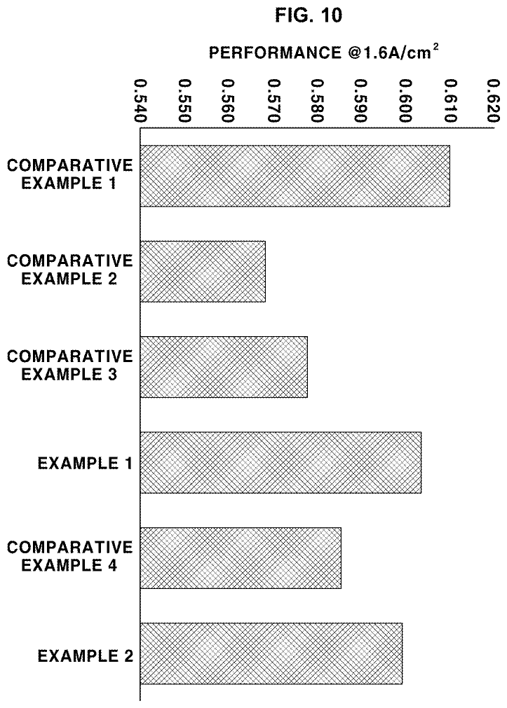

FIG. 10 shows the results of measuring the initial performance of the fuel cells having the cathode structures according to Examples 1 and 2 and Comparative examples 1 to 4.

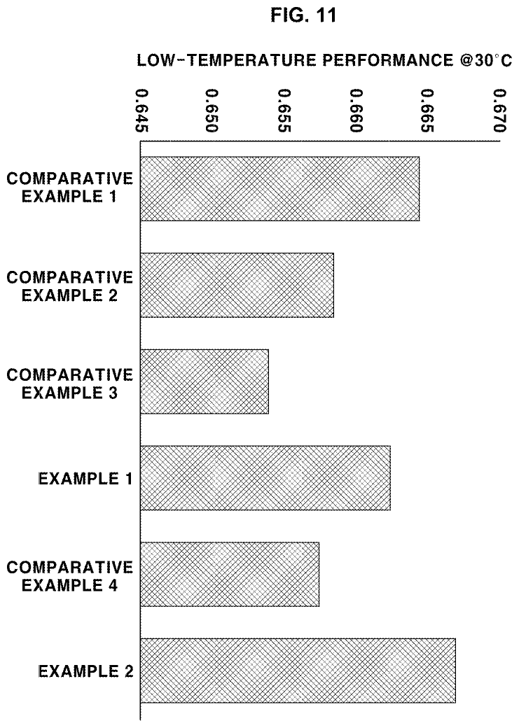

FIG. 11 shows the results of measuring low temperature (30° C.) performance of the fuel cells having the cathode structures according to Examples 1 and 2 and Comparative examples 1 to 4.

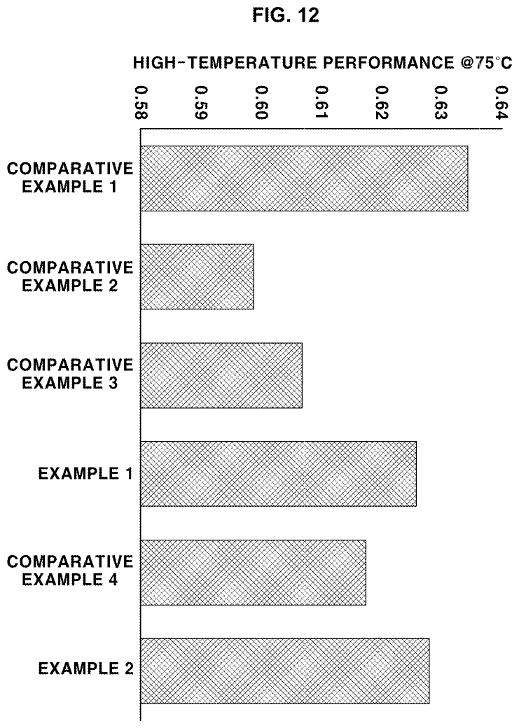

FIG. 12 shows the results of measuring high temperature (75° C.) performance of the fuel cells having the cathode structures according to Examples 1 and 2 and Comparative examples 1 to 4.

As shown in FIGS. 10 to 12, Examples 1 and 2 have all of excellent initial performance, low temperature performance, and high temperature performance compared to Comparative examples 2 to 4.

In addition, since the air introduction portion side corresponds to a vulnerable portion when analyzing the durability of each region in the membrane-electrode assembly to which the non-alloy catalyst is applied, the alloy catalyst having excellent durability can be applied to the portion, thereby solving the problem of lowering the durability of the non-alloy catalyst (Comparative example 1).

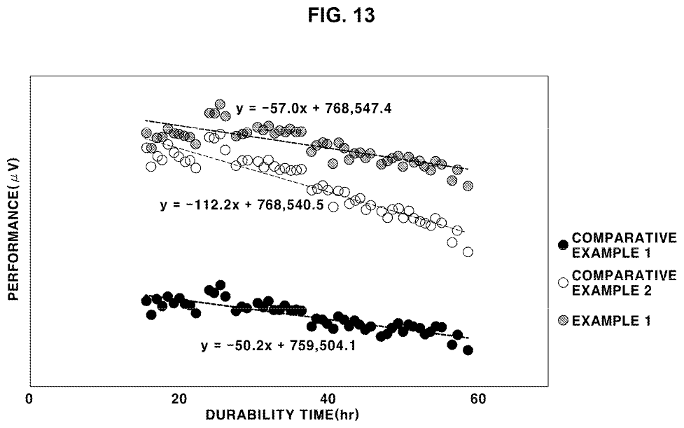

In particular, FIG. 13 shows the results of measuring the durability performance of the fuel cell having the cathode structures in Example 1, and Comparative examples 1 and 2. Referring to FIG. 13, Comparative example 1 shows the high initial performance, but a performance reduction slope is rapidly shown according to a durability time, whereas Example 1 has the high initial performance and a stable performance reduction rate compared to that of Comparative example 1 according to the durability time.

As described above, while the exemplary embodiments are described by the limited exemplary embodiments and drawings, those skilled in the art can variously modify and change the present invention from the above description. For example, even if the described technologies are performed in an order different from the described methods, and/or the described components are coupled or combined in a form different from the described methods, or replaced or substituted with other components or equivalents, appropriate results can be achieved. Therefore, other implementations, other examples, and those equivalent to the scope of claims also fall within the scope of the appended claims.

What is claimed is:

1. A cathode structure for being integrated into a fuel cell comprising an air introduction portion and an air discharge portion,
wherein the cathode structure comprises:
a first region disposed close to the air introduction portion when the cathode structure is integrated into the fuel cell and comprising a first catalyst, and
a second region being the remaining region excluding the first region and comprising a second catalyst; and
wherein the first catalyst comprises a first support body and an alloy catalyst supported by the first support body, and
wherein the second catalyst comprises a second support body and a non-alloy catalyst supported by the second support body.

2. The cathode structure of claim 1,
wherein the cathode structure comprises a pair of long sides facing each other and a pair of short sides facing each other, and
wherein the first region is disposed along any one of the pair of short sides.

3. The cathode structure of claim 1,
wherein the cathode structure comprises a pair of long sides facing each other and a pair of short sides facing each other, and
wherein the first region is disposed along any one of the pair of long sides.

4. The cathode structure of claim 1,
wherein the first region occupies about 30% to 70% of a surface area of the cathode structure.

5. The cathode structure of claim 1,
wherein the alloy catalyst has a formula of Pt-M,
wherein M comprises one or more selected from a group consisting of Co, Ni Ru, Cu, Fe, and Au.

6. The cathode structure of claim 1,
wherein the first catalyst comprises an amount of about 40 wt % to 80 wt % of the alloy catalyst and an amount of about 20 wt % to 60 wt % of the first support body,
all wt % based on the total weight of the first catalyst.

7. The cathode structure of claim 1,
wherein the non-alloy catalyst comprises a platinum (Pt).

8. The cathode structure of claim 1,
wherein the second catalyst comprises an amount of about 30 wt % to 70 wt % of the non-alloy catalyst and an amount of about 30 wt % to 70 wt % of the second support body,
all wt % based on the total weight of the second catalyst.

9. A fuel cell comprising:
a cathode structure,
an air introduction portion, and
an air discharge portion,
wherein the cathode structure comprises:
a first region disposed close to the air introduction portion when the cathode structure is integrated into the fuel cell and comprising a first catalyst, and
a second region being the remaining region excluding the first region and comprising a second catalyst; and
wherein the first catalyst comprises a first support body and an alloy catalyst supported by the first support body, and
wherein the second catalyst comprises a second support body and a non-alloy catalyst supported by the second support body.

10. The fuel cell of claim 9,
wherein the cathode structure comprises a pair of long sides facing each other and a pair of short sides facing each other, and
wherein the first region is disposed along any one of the pair of short sides.

11. The fuel cell of claim 9,
wherein the cathode structure comprises a pair of long sides facing each other and a pair of short sides facing each other, and
wherein the first region is disposed along any one of the pair of long sides.

12. The fuel cell of claim 9,
wherein the first region occupies about 30% to 70% of a surface area of the cathode structure.

13. The fuel cell of claim 9,
wherein the alloy catalyst has a formula of Pt-M,
wherein M comprises one or more selected from a group consisting of Co, Ni, Ru, Cu, Fe, and Au.

14. The fuel cell of claim 9,
wherein the first catalyst comprises an amount of about 40 wt % to 80 wt % of the alloy catalyst and an amount of about 20 wt % to 60 wt % of the first support body,
all wt % based on the total weight of the first catalyst.

15. The fuel cell of claim 9,
wherein the non-alloy catalyst comprises a platinum (Pt).

16. The fuel cell of claim 9,
wherein the second catalyst comprises an amount of about 30 wt % to 70 wt % of the non-alloy catalyst and an amount of about 30 wt % to 70 wt % of the second support body,
all wt % based on the total weight of the second catalyst.

17. A membrane-electrode assembly comprising a cathode structure of claim 1.
